(19) United States
(12) Patent Application Publication
(10) Pub. No.: US 2008/0053535 A1
(43) Pub. Date: Mar. 6, 2008

(54) CYLINDER VALVE REGULATOR

(76) Inventor: Don C. Leggitt, New Braunfels, TX (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/847,661

(22) Filed: Aug. 30, 2007

Related U.S. Application Data
(60) Provisional application No. 60/840,998, filed on Aug. 30, 2006.

(51) Int. Cl. F16K 31/12

(52) U.S. Cl. 137/505

(57) ABSTRACT

Assembly comprising a housing having valve and regulator portions, with the housing having an inlet, an outlet and a fluid path extending through the portions. The regulator portion includes a cavity, an inlet connected to the cavity and a outlet connected to the cavity. The regulator portion includes a member selectively covering an area of the cavity and a diaphragm connected to the member for selectively moving the covering member to cover the area. The regulator portion further includes a biasing member biasing the diaphragm to a position such that the member covers the area, with the diaphragm moving against the biasing member when pressure in the first area is above a predetermined amount, thereby forcing the member to cover the area such that fluid is not able to pass through the area and therefore the regulator portion. The valve portion includes a stop valve for stopping gas flow therethrough.

### FIELD OF THE INVENTION

This invention is applicable to a wide range of gas pressure-regulating applications, but is designed for particularly advantageous use in propane outdoor cooking appliance applications.

### SUMMARY OF THE PRESENT INVENTION

An aspect of the present invention is to provide a gas valve and regulator assembly comprising a housing having a valve portion and a regulator portion. The valve portion includes a first section and a second section. The first section has a first section fluid path, a first section inlet to the first section fluid path and a first section outlet allowing gas to leave the first section fluid path. The second section has a second section fluid path, a second section inlet to the second section fluid path and a second section outlet allowing gas to leave the second section fluid path. The regulator portion includes a regulator cavity, a regulator inlet connected to the regulator cavity and a regulator outlet connected to the regulator cavity. The regulator cavity includes an area separating the regulator cavity into a first zone and a second zone. The regulator portion further includes a covering member configured to selectively cover the area and a diaphragm operatively connected to the covering member for selectively moving the covering member to cover the area. The regulator portion also includes a biasing member biasing the diaphragm to a position such that the covering member covers the area. The diaphragm is configured to move against the biasing member when pressure in the first zone is above a predetermined amount, thereby forcing the covering member to cover the area such that fluid is not able to pass through the area and therefore the regulator portion. The valve portion includes a stop valve configured to selectively stop gas flow through one of the first section and the second section. The first section outlet of the first section of the valve portion is connected to the regulator inlet and the second section inlet of the second section of the valve portion is connected to the regulator outlet, thereby defining a fluid path through the housing from the first section of the valve portion, through the regulator portion and the second section of the valve portion.

Another aspect of the present invention is to provide a gas valve and regulator assembly comprising a housing having a valve portion and a regulator portion, with the housing having an inlet, an outlet and a fluid path between the inlet and the outlet, with the fluid path extending through the valve portion and the regulator portion. The regulator portion includes a regulator cavity, a regulator inlet connected to the regulator cavity and a regulator outlet connected to the regulator cavity. The regulator cavity includes an area separating the regulator cavity into a first zone and a second zone. The regulator portion further includes a covering member configured to selectively cover the area and a diaphragm operatively connected to the covering member for selectively moving the covering member to cover the area. The regulator portion further includes a biasing member biasing the diaphragm to a position such that the covering member covers the area. The diaphragm is configured to move against the biasing member when pressure in the first area is above a predetermined amount, thereby forcing the covering member to cover the area such that fluid is not able to pass through the area and therefore the regulator portion. The valve portion includes a stop valve configured to selectively stop gas flow through the valve portion. The regulator inlet and the regulator outlet are connected to the valve portion and define a portion of the fluid path.

Yet another aspect of the present invention is to provide a gas valve and regulator assembly comprising a housing, a covering member, a diaphragm, a biasing member and a valve. The housing has an inlet, an outlet and a fluid path between the inlet and the outlet. The housing includes a regulator cavity having an area separating the regulator cavity into a first zone and a second zone. The covering member is configured to selectively cover the area. The diaphragm is operatively connected to the covering member for selectively moving the covering member to cover the area. The biasing member biases the diaphragm to a position such that the covering member covers the area. The diaphragm is configured to move against the biasing member when pressure in the first area is above a predetermined amount, thereby forcing the covering member to cover the area such that fluid is not able to pass through the area and therefore the housing. The valve is configured to selectively stop gas flow through the housing and through the regulator cavity. The valve is not functionally connected to the diaphragm such that movement of the valve will not move the diaphragm. The valve is also not functionally connected to the covering member such that movement of the valve will not move the covering member.

These and other aspects, objects, and features of the present invention will be understood and appreciated by those skilled in the art upon studying the following specification, claims, and appended drawings.

### BRIEF DESCRIPTION OF THE DRAWINGS

The following brief description of the figures, and the related figures themselves, exemplifies a particular preferred embodiment of the invention constituting the best mode presently contemplated. As will be understood, other embodiments of the invention as well as changes and variations in the particular structure shown in these figures are no doubt possible, and may very well suggest themselves to those skilled in the art after studying this disclosure and these figures.

FIG. 1 is a front perspective view of a gas valve and regulator assembly in accordance with the present invention;

FIG. 2 is a rear perspective view of the gas valve and regulator assembly in accordance with the present invention;

FIG. 3 is a side view of the gas valve and regulator assembly in accordance with the present invention;

FIG. 4 is a first side view of the gas valve and regulator assembly in accordance with the present invention identical to the side view of FIG. 3, but with a regulator portion of the gas valve and regulator assembly removed for clarity;

FIG. 5 is a cross-sectional view of the gas valve and regulator assembly in accordance with the present invention taken along line V-V of FIG. 4;

FIG. 6 is a cross-sectional view of the gas valve and regulator assembly in accordance with the present invention taken along line VI-VI of FIG. 3;

FIG. 6A is an enlarged cross-sectional view of an excess control flow device in accordance with the present invention taken along the rectangular section VIA of FIG. 6;

FIG. 6B is an enlarged cross-sectional view of a back check device in accordance with the present invention taken along the rectangular section VIB of FIG. 6;

FIG. 7 is a front view of the gas valve and regulator assembly in accordance with the present invention, but with a regulator portion of the gas valve and regulator assembly removed for clarity;

FIG. 8 is a rear view of the gas valve and regulator assembly in accordance with the present invention;

FIG. 9 is a cross-sectional view of the gas valve and regulator assembly in accordance with the present invention taken along line IX-IX of FIG. 8;

FIG. 10 is a cross-sectional view of the gas valve and regulator assembly in accordance with the present invention taken along line X-X of FIG. 8;

FIG. 10A is an enlarged cross-sectional view of a back check device in accordance with the present invention taken along the rectangular section XA of FIG. 10;

FIG. 11 is a second side view of the gas valve and regulator assembly in accordance with the present invention, but with a regulator portion of the gas valve and regulator assembly removed for clarity; and

FIG. 12 is a top view of the gas valve and regulator assembly in accordance with the present invention, but with a regulator portion of the gas valve and regulator assembly removed for clarity.

### DETAILED DESCRIPTION OF PREFERRED EMBODIMENT

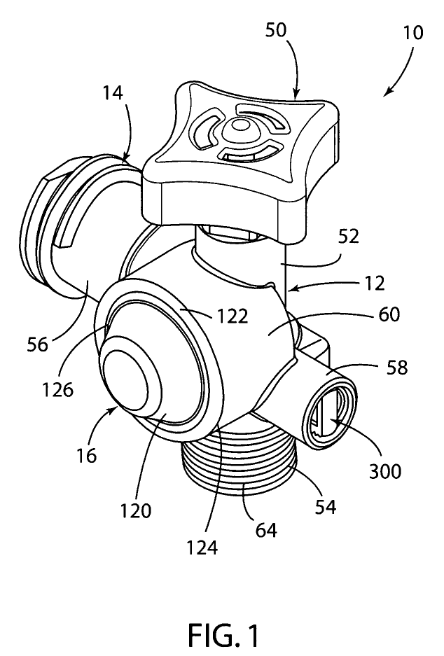

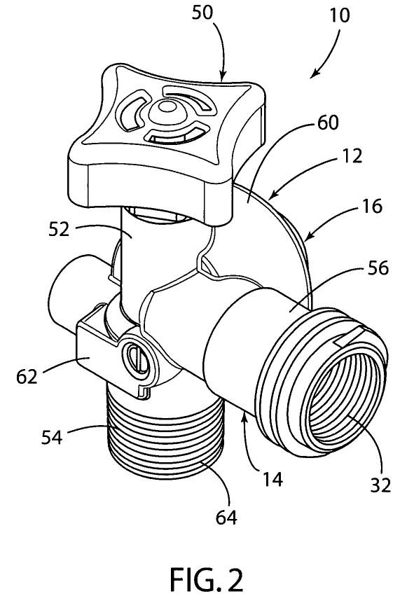

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

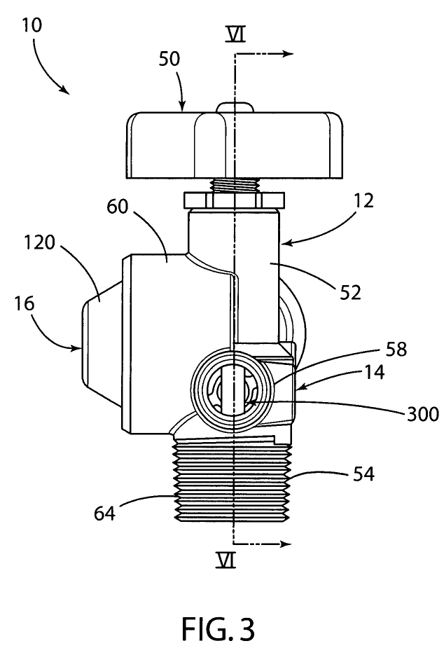

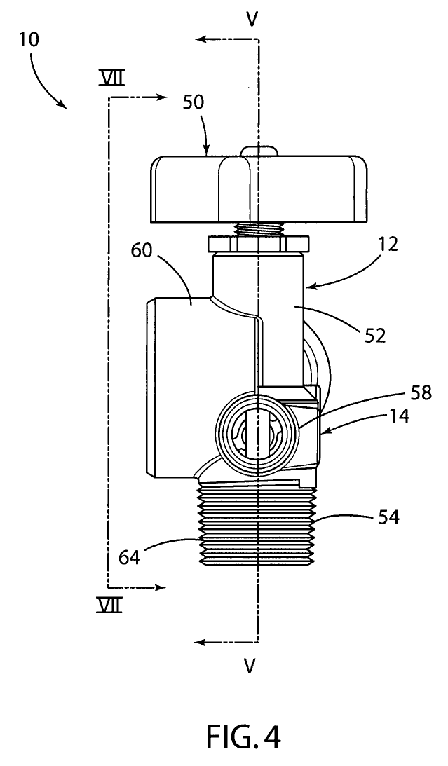

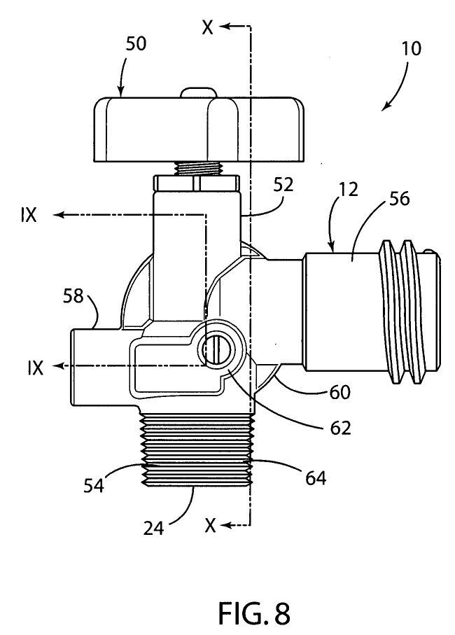

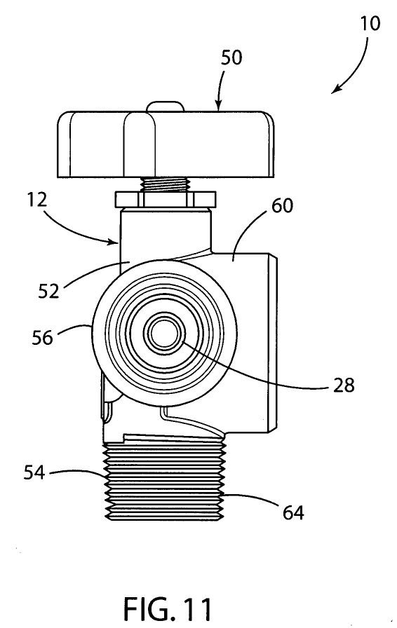

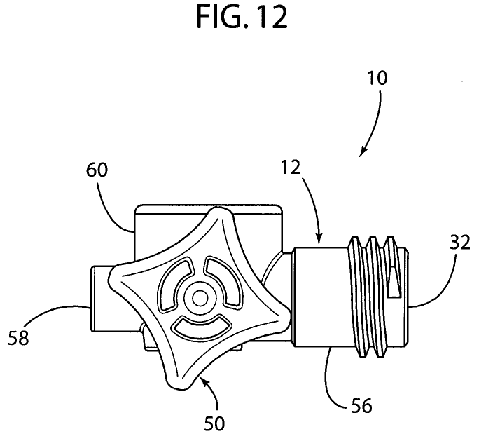

The reference number 10 (FIGS. 1-12) generally designates a gas valve and regulator assembly embodying the present invention. In the illustrated example, the gas valve and regulator assembly 10 comprises a housing 12 having a valve portion 14 and a regulator portion 16. The valve portion 14 includes a first section 18 and a second section 20. The first section 18 has a first section fluid path 22, a first section inlet 24 to the first section fluid path 22 and a first section outlet 26 allowing gas to leave the first section fluid path 22. The second section 20 has a second section fluid path 28, a second section inlet 30 to the second section fluid path 28 and a second section outlet 32 allowing gas to leave the second section fluid path 28. The regulator portion 16 includes a regulator cavity 34, a regulator inlet 36 connected to the regulator cavity 34 and a regulator outlet 38 connected to the regulator cavity 34. The regulator cavity 34 includes an area 38 separating the regulator cavity 34 into a first zone 40 and a second zone 42. The regulator portion 16 further includes a covering member 44 configured to selectively cover the area 38 and a diaphragm 46 operatively connected to the covering member 44 for selectively moving the covering member 44 to cover the area 38. The regulator portion 16 also includes a biasing member 48 biasing the diaphragm 46 to a position such that the covering member 44 covers the area 38. The diaphragm 46 is configured to move against the biasing member 48 when pressure in the first zone 40 is above a predetermined amount, thereby forcing the covering member 44 to cover the area 38 such that fluid is not able to pass through the area 38 and therefore the regulator portion 16. The valve portion 14 includes a valve 50 configured to selectively stop gas flow through one of the first section 18 and the second section 20. The first section outlet 26 of the first section 18 of the valve portion 14 is connected to the regulator inlet 36 and the second section inlet 30 of the second section 20 of the valve portion 14 is connected to the regulator outlet 38, thereby defining a fluid path through the housing 12 from the first section 18 of the valve portion 14, through the regulator portion 16 and the second section 20 of the valve portion 14.

The illustrated gas valve and regulator assembly 10 uniquely combines a pressure regulator with a valve. The gas valve and regulator assembly 10 includes the valve portion 14 that allows a user of the gas valve and regulator assembly 10 to manually shut off a flow of gas through the gas valve and regulator assembly 10. The gas valve and regulator assembly 10 also includes the regulator portion 16 that regulates the flow of gas through the gas valve and regulator assembly 10 and stops the flow of gas through the gas valve and regulator assembly 10 if the pressure in the gas valve and regulator assembly 10 rises above a certain level.

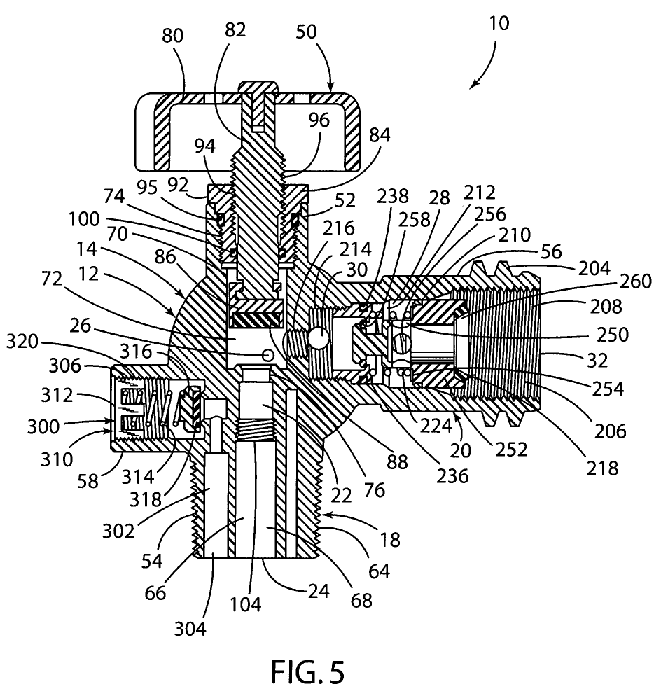

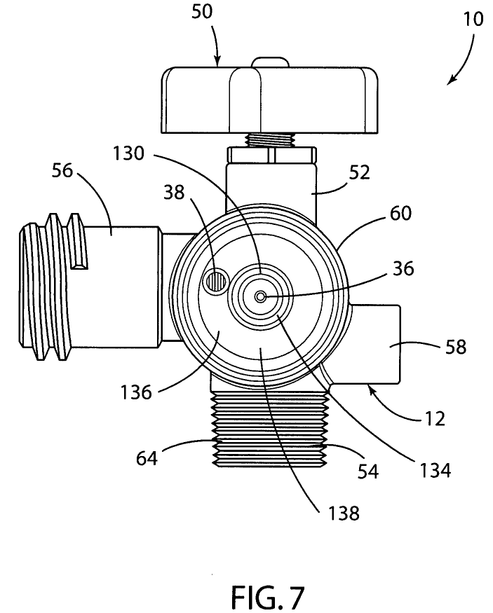

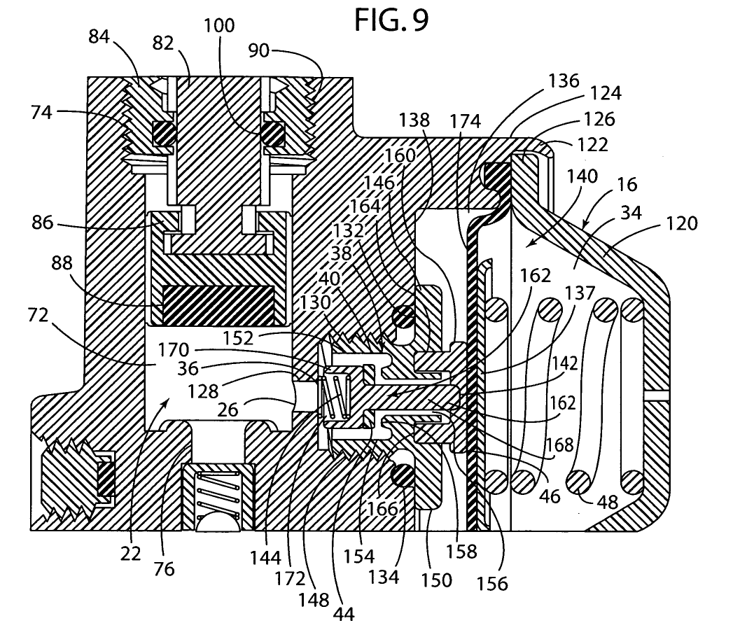

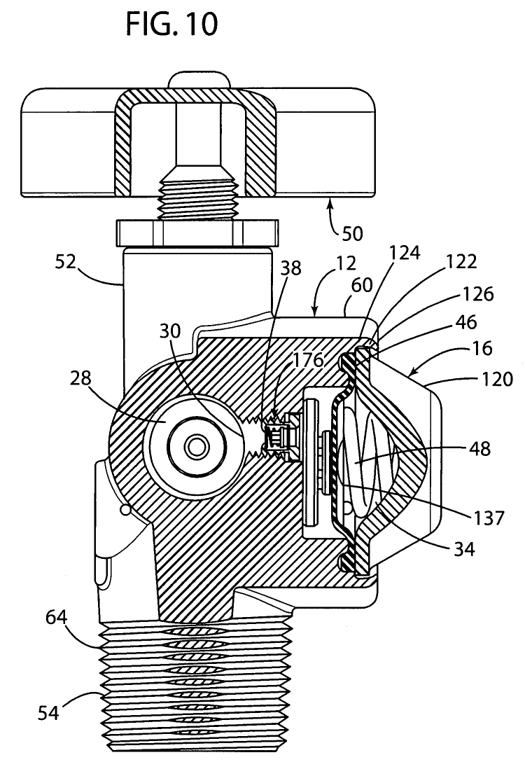

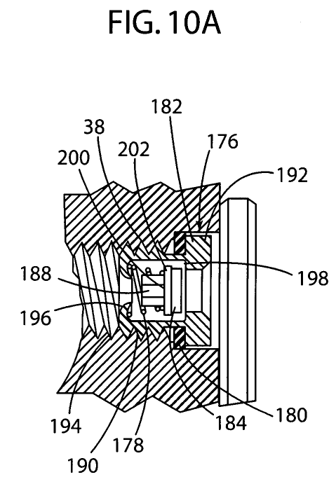

In the illustrated embodiment, gas flows through the first section 18 of the valve portion 14, then through the regulator portion 16 and then through the second section 20 of the valve portion 14. As illustrated in FIG. 5, the gas first enters the housing 12 at the first section inlet 24 of the first section 18 of the valve portion 14. The gas then flows through the first section fluid path 22 to the first section outlet 26. At this point, the gas exits the valve portion 14 of the gas valve and regulator assembly 10 and into the regulator portion 16 of the gas valve and regulator assembly 10. FIGS. 7 and 9 illustrate the regulator inlet 36 of the regulator portion 16. The gas in the gas valve and regulator assembly 10 flows through the regulator inlet 36, which is connected to the first section outlet 26 of the first section 18 of the valve portion 14, and into the regulator cavity 34 in the regulator portion 16. If the gas is not above a certain pressure, the gas will flow through the regulator cavity 34 to the regulator outlet 38 as illustrated in FIGS. 7 and 10. Once the gas flows through the regulator outlet 38, the gas will reenter the valve portion 14 of the gas valve and regulator assembly 10 through the second section inlet 30 and into the second section fluid path 28 of the second section 20 of the valve portion 14. Finally, the gas will flow through the second section fluid path 28 of the second section 20 of the valve portion 14 and out of the gas valve and regulator assembly 10 through the second section outlet 32.

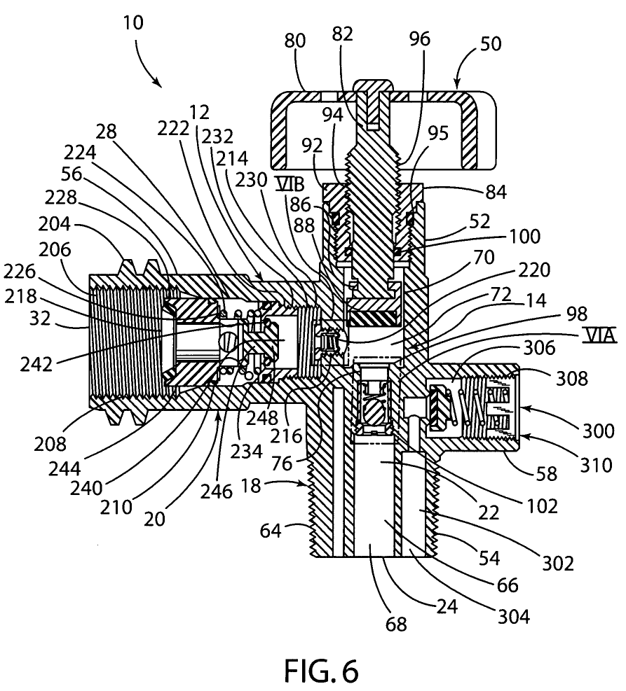

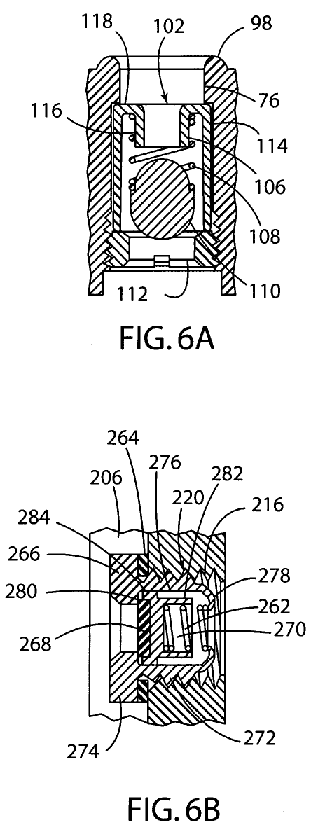

The illustrated housing 12 of the gas valve and regulator assembly 10 comprises the valve portion 14 and a regulator portion 16. The housing 12 comprises a plurality of interconnected and integral cylinder portions (see FIGS. 1-6, 7, 8 and 10-12). The housing 12 includes an upward cylinder 52, a downward cylinder 54, a left cylinder 56, a right cylinder 58, a front cylinder 60 and a rear cylinder 62. The valve portion 14 and a regulator portion 16 of the gas valve and regulator assembly 10 are located in at least one of the cylinders. FIGS. 5 and 6 illustrate the upward cylinder 52, the downward cylinder 54, the left cylinder 56 and the right cylinder 58. In the illustrated embodiment, the first section 18 of the valve portion 14 is located in the upward cylinder 52 and the downward cylinder 54. Furthermore, the second section 20 of the valve portion 14 is located in the left cylinder 56. Moreover, the regulator portion 16 is located in the front cylinder 60.

In the illustrated embodiment, the first section 18 of the valve portion 14 accepts gas therein and supplies gas to the regulator portion 16. As discussed above, the first section 18 of the valve portion 14 is located in the upward cylinder 52 and the downward cylinder 54 (see FIGS. 5, 6 and 9). The downward cylinder 52 includes a threaded outer surface 64 for screwing the gas valve and regulator assembly 10 onto a supply of gas or a connection to a supply of gas. The downward cylinder 54 also includes a center opening 66 defining the first section inlet 24 and a first portion 68 of the first section fluid path 22. The downward cylinder 54 is aligned with the upward cylinder 52. The upward cylinder 54 includes a center opening 70 that is aligned with the center opening 66 in the downward cylinder 54. The center opening 70 defines a second portion 72 of the first section fluid path 22, the first section outlet 26 and a threaded inner surface 74 for accepting the valve 50. A constriction 76 separates the first portion 68 of the first section fluid path 22 from the second portion 72 of the first section fluid path 22. The valve 50 is configured to close the first section fluid path 22 at the constriction 76 to stop the flow of gas through the gas valve and regulator assembly 10.

The illustrated valve 50 (FIGS. 5, 6 and 9) is configured to be rotated to stop the flow of the gas through the gas valve and regulator assembly 10. The valve 50 includes a valve knob 80, a valve stem 82, a valve stem housing 84, a valve disc holder 86, and a valve disc 88. The valve stem housing 84 is tubular and includes a threaded outer surface 90, an outer ledge 92 and an inner threaded surface 94. The valve stem housing 84 is screwed into the center opening 70 of the upward cylinder 52 of the housing 12 until the outer ledge 92 abuts against a top of the upward cylinder 52. As illustrated in FIGS. 5 and 6, an O-ring 95 surrounds the valve stem housing 84 and is located between the outer ledge 92 and the inner surface of the center opening 70 to assist in preventing gas flow around the valve stem housing 84 and out of the housing 12. The valve stem 82 includes an outer threaded surface 96 and is screwed into the valve stem housing 84. As illustrated in FIGS. 5 and 6, an O-ring 100 surrounds the valve stem 82 and is located between the valve stem 82 and the inner surface of the valve stem housing 84 to assist in preventing gas flow around the valve stem 82 and out of the housing 12. The valve knob 80 is connected to a first end of the valve stem 82 outside of the upward cylinder 52 and the valve disc holder 86 is connected to a second end of the valve stem 82. The valve disc 88 is connected to the valve disc holder 86. The valve stem 82 is configured to be rotated in the valve stem housing 84 (via rotation of the valve knob 80) to move valve stem 82 towards and away from the constriction 76.

In the illustrated example, the valve 50 abuts the constriction 76 in the first section fluid path 22 of the first section 18 of the valve portion 14 of the gas valve and regulator assembly 10 to prevent the flow of gas through the gas valve and regulator assembly 10. As illustrated in FIGS. 5 and 6, the constriction 76 includes an upwardly extending circular ridge 98. As a user of the gas valve and regulator assembly 10 rotates the valve knob 80, the valve stem 82 is rotated within the valve stem housing 84 to move the valve stem 82, and therefore the valve disc holder 86 and the valve disc 88, towards the constriction 76. As the valve disc 88 moves towards the constriction 76, the valve disc 88 will slow the flow of gas through the constriction 76. After full rotation of the valve stem 82, the valve disc 88 will abut the circular ridge 98 at the constriction 76 and positively stop flow of gas through the constriction 76. Since the constriction is located between the first section inlet 24 and the first section outlet 26 as illustrated in FIG. 5, stopping flow through the constriction 76 will prevent the flow of gas through the gas valve and regulator assembly 10.

As illustrated in FIGS. 6 and 6A, the first section 18 of the valve portion 14 of the gas valve and regulator assembly 10 includes an excess control flow device 102 for preventing excess flow through the first section fluid path 22. As illustrated in FIG. 5, the center opening 66 of the downward cylinder 54 includes an inner threaded surface 104 below the constriction 76. The inner threaded surface 104 (see FIG. 5) holds the excess control flow device 102 (which is not shown in FIG. 5). The excess control flow device 102 includes an excess flow body 106, an excess flow spring 108, an excess flow plug 110 and an excess flow cap 112. The excess flow body 106 includes an outer tubular body 114, an inner tubular body 116 and a connection portion 118 connecting the outer tubular body 114 to the inner tubular body 116. The connection portion 118 abuts against a bottom of the constriction 76. The excess flow cap 112 is screwed into the inner threaded surface of the center opening 66 to maintain the excess flow body 106 in position in the center opening 66. The excess flow spring 108 surrounds the inner tubular body 116 of the excess flow body 106 and is connected to the excess flow plug 110. If the flow of gas through the excess control flow device 102 is above a predetermined amount, the gas will push the excess flow plug 110 against the bias of the excess flow spring 108 until the excess flow plug 110 abuts the inner tubular body 116 of the excess flow body 106, thereby preventing excess flow of gas through the excess control flow device 102. After the gas passes through the excess control flow device 102 (if the gas is not flowing excessively) and after the gas passes the constriction 76 (if the valve 50 is not closed), the gas will exit the first section 18 of the valve portion 14 of the gas valve and regulator assembly 10 through the first section outlet 26 and will enter the regulator portion 16 through the regulator inlet 36.

In the illustrated example, the regulator portion 16 (FIGS. 7, 9 and 10) of the gas valve and regulator assembly 10 accepts gas in through the regulator inlet 36 and the gas exits the regulator portion 16 through the regulator outlet 38. The regulator portion 16 of the gas valve and regulator assembly 10 is located on the front cylinder 60 of the housing 12. The regulator portion 16 comprises the front cylinder 60 and a bonnet 120 connected thereto. The bonnet 120 and the front cylinder 60 may be substantially cylindrical. The bonnet 120 is connected to the front cylinder 60 by mechanically deforming, or crimping, a flange 122 on an outside of an end portion 124 of the front cylinder 60 over an outer flange 126 of the bonnet 120. The crimp could also be reversed with a flange on the outside of the bonnet 120 and an outer flange on the front cylinder 60. Alternatively, the bonnet 120 can have an outer flange at an end, which connects to the front cylinder 60 by a plurality of threaded fasteners.

As illustrated in FIGS. 7 and 9, the front cylinder 60 includes a centrally located hole 128 defining the first section outlet 26 at one end and the regulator inlet 36 at the other end. An internally threaded opening 130 is located co-linear with the hole 128. An O-ring 132 rests in a groove 134 at the end of the threaded opening 130. The front cylinder 60 further includes a counter bore 136, with the internally threaded opening 130 being centrally located in the counter bore 136. The regulator outlet 38 is located in a base surface 138 of the counter bore 136.

In the illustrated example, the pressure regulator 10 includes a regulating assembly 140 for controlling the flow of fluid from the regulator inlet 36 to the regulator outlet 38. The regulating assembly 140 is located within the regulator cavity 34 defined by the bonnet 120 and the front cylinder 60. The regulating assembly 140 includes the diaphragm 46, a support plate 137 on the diaphragm 46, a two-part stem-like actuator 142, the biasing member 48 located between the diaphragm 46 (and the support plate 137) and the bonnet 120, a spring 144, the covering member 44 and a plug 146. The plug 146 is tubular and includes an outside threaded first end 148 and an annular flange 150 at a second end. The plug 146 includes a central hole 152 having a wider area 154 and a narrower area 156, with the narrower area 156 defining a constriction in the plug 146. A ridge 158 is located at the transition between the wider area 154 and the narrower area 156. The constriction defines the area 38 of the regulator cavity 34 that separates the regulator cavity 34 into the first zone 40 and the second zone 42.

The illustrated regulating assembly 140 is configured to force the covering member 44 to cover the area 38 such that fluid is not able to pass through the area 38 and therefore the regulator portion 16 when the pressure in the regulator portion 16 rises above a certain level. The regulator portion 16 includes the biasing member 48 that biases the diaphragm 46 to a position such that the covering member 44 covers the area 38. The illustrated diaphragm 46 is clamped between the front cylinder 60 and the bonnet 120. The diaphragm 46 is biased towards the left as illustrated in FIG. 9 by the biasing member 48, which acts against a right side of the diaphragm 46 (via the support plate 137). The diaphragm 46 is connected to the two-part stem-like actuator 142. The two-part stem-like actuator 142 includes a first portion 160 connected to the diaphragm 46 and a second portion 162 that extends through the narrower area 156 of the central hole 152 in the plug 146. The first portion 160 includes a plurality of pins 164 that are accepted into corresponding cavities 166 in the plug 146. The pins 164 are configured to slide with the cavities 166 to help maintain alignment of the two-part stem-like actuator 142 in the plug 146. The second portion 162 of the two-part stem-like actuator 142 includes a shaft 168 in contact with the first portion 160 of the two-part stem-like actuator 142 and a plate 170 at the end of the shaft 168 opposite the first portion 160 of the two-part stem-like actuator 142. The covering member 44 is a disc that surrounds the shaft 168 and abuts against the plate 170. A bottom of the plate 170 includes a counter bore 172 accepting the spring 144 therein. The spring 144 biases the plate 170, and therefore the covering member 44, towards the constriction in the plug 146.

During typical use of the illustrated regulator portion 16, fluid flows into the regulator inlet 36 and into the regulator cavity 34 of the regulator portion 16. The fluid then flows through the regulator outlet 38 and to the second section 20 of the valve portion 14 of the gas valve and regulator assembly 10. However, when pressure in the regulator cavity 34 raises above a certain level, the gas in the regulator cavity 34 will press against an underside 174 of the diaphragm 46 and move the diaphragm 46 against the bias of the biasing member 48. In this situation, the movement of the diaphragm 48 will move the two-part stem-like actuator 142 to the right as illustrated in FIG. 9. Rightward movement of the two-part stem-like actuator 142 will force the covering member 44 into engagement with the ridge 158 in the plug 146, thereby closing the central hole 152 in the plug 146. Accordingly, when the pressure in the regulator cavity 34 is above a certain level, the covering member 44 will cover the constriction in the plug 146 and prevent fluid flow through the plug 146 and into the second zone 42 of the regulator cavity 34 of the regulator portion 16 of the gas valve and regulator assembly 10.

In the illustrated example, if the gas can flow through the regulating assembly 140, the gas will exit out of the regulator outlet 38. As illustrated in FIGS. 7 and 10, the regulator outlet 38 is located in a base surface 138 of the counter bore 136 such that the plug 146 does not prevent gas from exiting the regulator cavity 34 through the regulator outlet 38. Furthermore, the regulator outlet 38 includes a first backcheck valve 176 therein for preventing flow of gas into the regulator cavity 34 through the regulator outlet 38. The first backcheck valve 176 (FIG. 10A) comprises a first backcheck spring 178, a first backcheck gasket 180, a first backcheck housing 182, a first backcheck disc 184 and a first backcheck stem 188. The first backcheck housing 182 is tubular and includes an outside threaded portion 190 and an annular flange 192 at one end of the outside threaded portion 190. The regulator outlet 38 includes an inside threaded surface 194 for accepting the outside threaded portion 190 of the first backcheck valve 176 therein. The first backcheck housing 182 further includes a central bore 194 having an annular inwardly extending hook 196 at one end and a centrally located step 198. The first backcheck disc 184 is connected to one end of the first backcheck stem 188, and both are located in the central bore 194 of the first backcheck housing 182. The first backcheck stem 188 includes a post portion 200 and a plate 202. The first backcheck disc 184 is connected to the plate 202 of the first backcheck stem 188. As illustrated in FIG. 10A, the first backcheck spring 178 is located between the annular inwardly extending hook 196 of the central bore 194 of the first backcheck housing 182 and the plate 202 of the first backcheck stem 188. The first backcheck spring 178 biases the plate 202 and the first backcheck disc 184 towards the step 198 in the central bore 194 of the first backcheck housing 182. As gas enters the regulator outlet 38, the gas will press against the first backcheck disc 184 and push the first backcheck disc 184 away from the step 198 in the central bore 194 of the first backcheck housing 182, thereby allowing the gas to flow through the first backcheck valve 176. However, once gas stops entering the regulator outlet 38, the first backcheck spring 178 will push the first backcheck disc 184 (via the first backcheck stem 188) back against the step 198 in the central bore 194 of the first backcheck housing 182 to prevent gas flow back into the regulator cavity 34. Once gas flows through the first backcheck valve 176 and the regulator outlet 38, the gas will enter the second section inlet 30 of the second section 20 of the valve portion 14 of the gas valve and regulator assembly 10.

The illustrated second section 20 of the valve portion 14 of the gas valve and regulator assembly 10 is located in the left cylinder 56 of the housing 12 (see FIGS. 5 and 6). The left cylinder 56 includes an outside threaded surface 204 and an inside bore 206. The left cylinder 56 is configured to have a tube or other connection device screwed thereon for supplying gas to the tube or other connection device through the gas valve and regulator assembly 10. The inside bore 206 includes (moving from right to left in FIG. 5) a first inside threaded portion 208 adjacent the second section outlet 32, a smooth portion 210 having a step 212, a second threaded portion 214 and a third threaded portion 216. The first inside threaded portion 208 is configured to have a tube or other connection device screwed thereon for supplying gas to the tube or other connection device through the gas valve and regulator assembly 10. Therefore, the tube or other connection device can be connected to the gas valve and regulator assembly 10 using either or both of the outside threaded surface 204 of the first inside threaded portion 208. The second section inlet 30 is located in the second threaded portion 214 of the inside bore 206. A valve module 218 is located in the inside bore 206 and a second backcheck valve 220 (which is not shown in FIG. 5) is located in the third threaded portion 216 as discussed in more detail below.

In the illustrated example, gas enters the second section 20 of the valve portion 14 of the gas valve and regulator assembly 10 through the regulator inlet 36, goes through the valve module 218 in the inside bore 206 and exits the gas valve and regulator assembly 10 through the second section outlet 32. The valve module 218 is configured to prevent gas flowing through the second section 20 of the valve portion 14 of the gas valve and regulator assembly 10 until the gas valve and regulator assembly 10 is connected to the tube or other connection device. The valve module 218 includes a seat 222, a spring 224, a washer 226 and a plug 228. The seat 222 is tubular and includes an outside surface 230 that includes a first end threaded portion 232 and a second end rim 234. The first end threaded portion 232 is screwed into the second threaded portion 214 of the inside bore 206 of the left cylinder 56. The second end rim 234 has a groove 236 with a first O-ring 238 therein. The first O-ring 238 is wedged between the second end rim 234 and the smooth portion 210 of the inside bore 206 of the left cylinder 56. The seat 222 includes a central aperture 240 with an inner ledge 242 inside the seat 222 at the end of the seat 222 with the second end rim 234. The plug 228 includes a receiving portion 244, a stem 246 and a cap 248, with the stem 246 extending through the inner ledge 242 and the cap 248 being located in the central aperture 240 of the seat 222. The receiving portion 244 comprises a small cylinder 250 at a first end and a large cylinder 252 at a second end, with a step 254 being located between the small cylinder 250 and the large cylinder 252. The small cylinder 250 includes a plurality of ports 256 for allowing gas to enter the plug 228 and to pass through the plug 228. The washer 226 is located on the step 254 between the small cylinder 250 and the large cylinder 252. The spring 224 is positioned between the washer 226 and the second end of the seat 222, thereby biasing the receiving portion 244 of the plug 228 away from the seat 222.

Before any item is connected to the gas valve and regulator assembly 10, the spring 224 will bias the receiving portion 244 of the plug 228 away from the seat 222. As the receiving portion 244 of the plug 228 is biased away from the seat 222, the stem 246 will move to the right as illustrated in FIG. 5 through the seat 222. Furthermore, the cap 248 of the plug 228 will move into engagement with the inner ledge 242 of the seat 222. The cap 248 includes a seal ring 258 on an outside thereof. As the seal ring 258 moves into engagement with the inner ledge 242 of the seat 222, the seal ring 258 will seal the central aperture 240 of the seat 222, thereby preventing gas flow through the valve module 218.

However, when the gas valve and regulator assembly 10 is connected to the tube or other connection device as described above, a probe on the tube or other connection device will push the receiving portion 244 of the plug 228 towards the seat 222. The receiving portion 244 preferably includes a seal ring 260 for accepting the probe and for sealing the probe to the receiving portion 244. As the probe pushes the stem 246 of the plug 228 to the left as illustrated in FIG. 5 through the seat 222, the cap 248 and the seal ring 258 move away from the inner ledge 242 of the seat 222, thereby allowing gas to flow through the valve module 218.

In the illustrated example, the second backcheck valve 220 (see FIGS. 6 and 6B) is located in the third threaded portion 216 of the inside bore 206 of the left cylinder 56. The third threaded portion 216 opens into the second portion 72 of the first section fluid path 22 of the first section 18 of the valve portion 14 of the gas valve and regulator assembly 10. The second backcheck valve 220 allows gas to exit the second portion 20 of the valve portion 14 and enter the first portion 18 of the valve portion 14. The second backcheck valve 220 comprises a second backcheck spring 262, a second backcheck gasket 264, a second backcheck housing 266, a second backcheck disc 268 and a second backcheck stem 270. The second backcheck housing 266 is tubular and includes an outside threaded portion 272 and an annular flange 274 at one end of the outside threaded portion 272. The third threaded portion 216 accepts the outside threaded portion 272 of the second backcheck valve 220 therein. The second backcheck housing 266 further includes a central bore 276 having an annular inwardly extending hook 278 at one end and a centrally located step 280. The second backcheck disc 268 is connected to one end of the second backcheck stem 270, and both are located in the central bore 276 of the second backcheck housing 266. The second backcheck stem 270 includes a post portion 282 and a plate 284. The second backcheck disc 268 is connected to the plate 284 of the second backcheck stem 270. As illustrated in FIG. 6B, the second backcheck spring 262 is located between the annular inwardly extending hook 278 of the central bore 276 of the second backcheck housing 266 and the plate 284 of the second backcheck stem 270 (within the stem 270). The second backcheck spring 262 biases the plate 284 and the second backcheck disc 268 towards the step 280 in the central bore 276 of the second backcheck housing 266.

In use, as gas enters the third threaded portion 216 from the second portion 72, the gas will press against the second backcheck disc 268 and push the second backcheck disc 268 onto the step 280 in the central bore 276 of the second backcheck housing 266, thereby not allowing the gas to flow through the second backcheck valve 220 from the second portion 72 to the second section 20 of the valve portion 14. Furthermore, gas attempting to enter the third threaded portion 216 directly from the second section inlet 30 will not overcome the force of the second backcheck spring 262 as the pressure of the gas entering the second section 20 of the valve portion 14 from the regulator portion 16 through the second section inlet 30 will not be great enough to overcome the force of the second backcheck spring 262. However, gas under a higher pressure (into the second section 20 through the second section outlet 32) can flow from through the second backcheck valve 220 and into the second portion 72 of the first section fluid path 22 and path 68 of the first section 18 of the valve portion 14 to thereafter allow the gas to enter the storage cylinder. The second backcheck valve 220 is used when the valve module 218 is open, the regulator portion 16 is closed and pressure between the regulator portion 16 and the valve module 218 is above a certain level (i.e., that is when the pressure in this area will overcome the bias of the second backcheck spring 262).

The illustrated gas valve and regulator assembly 10 further includes a release valve 300 (FIGS. 5 and 6) that is connected to the source of gas, but not to the valve portion 14 or the regulator portion 16 of the gas valve and regulator assembly 10. The release valve 300 is located in the downward cylinder 54 and the right cylinder 58. The release valve 300 includes an inverted L-shaped release valve tube 302 having a first portion 304 in the downward cylinder 54 and a second portion 306 in the right cylinder 58. The first portion 304 opens into the source of gas when the source of gas is connected to the gas valve and regulator assembly 10. The second portion 306 includes a threaded inner surface 308 that opens to the atmosphere. A release valve assembly 310 is located in the second portion 306. The release valve assembly 310 comprises a cap 312, a spring 314, a disc holder 316 and a disc 318. The cap 312 has an M-shaped cross-section with an outer threaded surface 320. The outer threaded surface of the cap 312 is screwed into the threaded inner surface 208 of the second portion 306 of the inverted L-shaped release valve tube 302. The spring 314 sits in the cap 312 between the outer legs and the inner leg of the cap 312. The spring 314 presses against the disc holder 316, which holds the disc 318. During normal operating pressure, the spring 314 biases the disc holder 316 and the disc 318 against the end second portion 306 of the inverted L-shaped release valve tube 302, thereby preventing gas from flowing through the inverted L-shaped release valve tube 302. However, if the pressure of the gas in the source of gas rises above a certain level, the gas will push against the disc 318 to overcome the bias of the spring 314, thereby allowing the gas to escape through the release valve 300.

The pressure regulator of the present invention provides a simplified and very compact design that can be incorporated into various regulator designs with slight modifications and should not be considered only unique to the disclosed design. It should be noted that in the event there is no downstream demand, gas pressure increases inside the regulator cavity until the closure member forms a seal in the regulator cavity, causing a zero flow or lockup condition. In this regard, the described invention also includes a safety feature commonly referred to as pressure control. As described previously, the mechanism of this device operates to control output flow pressure to meet downstream demand. When demand increases, outlet pressure decreases and this results in downward movement of the diaphragm and its related parts, including the stem-like actuator, causing the closure member to move incrementally away from the area 38 and thereby allowing more flow through the device to supply the new demand at the same regulated pressure. This continues until the demand is satisfied and an equilibrium state is reached. Conversely, the same events occur in reverse for conditions of decreasing demand. Changes in inlet pressure and/or demand will cause the device to compensate by opening or closing the regulating assembly in response to and in accordance with the new conditions, to again reach an equilibrium state. Furthermore, the valve portion 14 can be employed to positively open or close the gas valve and regulator assembly 10. All of these goals can be accomplished in one unique housing.

The foregoing detailed description is considered that of a preferred embodiment only, and the particular shape and nature of at least some of the components in this embodiment are at least partially based on manufacturing advantages and considerations as well as on those pertaining to assembly and operation. Modifications of this embodiment may well occur to those skilled in the art and to those who make or use the invention after learning the nature of this preferred embodiment, and the invention lends itself advantageously to such modification and alternative embodiments. For example, the regulator portion 16 can include any of the regulator configurations disclosed in U.S. Pat. Nos. 5,881,765; 6,668,855; and 6,971,403; U.S. Patent Publication Nos. 2004-0007270 A1 and 2005-0166969 A1 and U.S. Patent Application No. 60/802,633 entitled PRESSURE REGULATOR WITH IMPROVED OUTLET PRESSURE CONTROL, the entire contents of all of which are hereby incorporated herein by reference. Furthermore, the gas valve and regulator assembly 10 can include any of the indicators disclosed in U.S. Pat. No. 6,223,769 or U.S. Patent Application No. 60/837,996 (Atty. Doc. No. LEG03 PP-333 invented by Don C. Leggitt, Jr.) entitled GAS PRESSURE REGULATOR INDICATOR. Moreover, the gas valve and regulator assembly 10 can include the bonnet securement scheme as disclosed in U.S. Pat. No. 6,672,331. Therefore, it is to be understood that the embodiment shown in the drawings and described above is provided principally for illustrative purposes and should not be used to limit the scope of the invention.

We claim:

1. A gas valve and regulator assembly comprising:
a housing having a valve portion and a regulator portion, with the valve portion including a first section and a second section;
the first section has a first section fluid path, a first section inlet to the first section fluid path and a first section outlet allowing gas to leave the first section fluid path;
the second section has a second section fluid path, a second section inlet to the second section fluid path and a second section outlet allowing gas to leave the second section fluid path;
the regulator portion includes a regulator cavity, a regulator inlet connected to the regulator cavity and a regulator outlet connected to the regulator cavity; with the regulator cavity including an area separating the regulator cavity into a first zone and a second zone, the regulator portion further includes a covering member configured to selectively cover the area and a diaphragm operatively connected to the covering member for selectively moving the covering member to cover the area, the regulator portion also includes a biasing member biasing the diaphragm to a position such that the covering member covers the area;
the diaphragm is configured to move against the biasing member when pressure in the first zone is above a predetermined amount, thereby forcing the covering member to cover the area such that fluid is not able to pass through the area and therefore the regulator portion;
the valve portion includes a stop valve configured to selectively stop gas flow through one of the first section and the second section;
the first section outlet of the first section of the valve portion is connected to the regulator inlet and the second section inlet of the second section of the valve portion is connected to the regulator outlet, thereby defining a fluid path through the housing from the first section of the valve portion, through the regulator portion and the second section of the valve portion.

2. The gas valve and regulator assembly of claim 1, wherein:
the housing includes a release valve having a release valve inlet adjacent the first section inlet, the release valve allowing pressure in a source of gas connected to the assembly to decrease when the pressure rises above a certain level, the release valve being located in a release valve fluid path through the housing, the release valve fluid path not being fluidly connected to the fluid path.

3. The gas valve and regulator assembly of claim 1, further including:
a backcheck valve for preventing flow of gas into the regulator cavity through the regulator outlet.

4. The gas valve and regulator assembly of claim 3, wherein:
the backcheck valve includes a backcheck spring biasing a backcheck disc into engagement with a backcheck housing, the backcheck disc preventing fluid flow into the regulator cavity through the regulator outlet.

5. The gas valve and regulator assembly of claim 1, further including:
a backcheck valve for allowing gas to leave the second section of the valve portion and enter the first section of the valve portion, the backcheck valve allowing gas to flow to the first section when the stop valve is open, the regulator portion is closed and pressure between the regulator portion and the valve portion is above a certain level.

6. The gas valve and regulator assembly of claim 5, wherein:
the backcheck valve includes a backcheck spring biasing a backcheck disc into engagement with a backcheck housing, the backcheck disc preventing fluid flow into the regulator cavity through the regulator outlet.

7. The gas valve and regulator assembly of claim 1, wherein:
the stop valve allows for positive shut off of fluid flow through the fluid path.

8. The gas valve and regulator assembly of claim 1, wherein:
the stop valve stops fluid flow through the first section of the valve portion.

9. The gas valve and regulator assembly of claim 1, wherein:
the first section inlet and the first section outlet are substantially perpendicular;
the regulator inlet and regulator outlet are substantially parallel; and
the second section inlet and the second section outlet are substantially perpendicular.

10. The gas valve and regulator assembly of claim 1, wherein:
the second section includes a valve module for preventing fluid flow through the second section until a probe is inserted into the assembly through the second section outlet.

11. The gas valve and regulator assembly of claim 1, further including:
an excess control flow device for preventing excess flow through the fluid path, the excess flow device having a body configured to abut a member when the flow through the fluid path exceeds a certain amount.

12. The gas valve and regulator assembly of claim 11, wherein:
the excess control flow device is located in the first section fluid path.

13. A gas valve and regulator assembly comprising:
a housing having a valve portion and a regulator portion, with the housing having an inlet, an outlet and a fluid path between the inlet and the outlet, with the fluid path extending through the valve portion and the regulator portion;
the regulator portion includes a regulator cavity, a regulator inlet connected to the regulator cavity and a regulator outlet connected to the regulator cavity;
the regulator cavity includes an area separating the regulator cavity into a first zone and a second zone;
the regulator portion further includes a covering member configured to selectively cover the area and a diaphragm operatively connected to the covering member for selectively moving the covering member to cover the area;
the regulator portion further includes a biasing member biasing the diaphragm to a position such that the covering member covers the area;
the diaphragm is configured to move against the biasing member when pressure in the first area is above a predetermined amount, thereby forcing the covering member to cover the area such that fluid is not able to pass through the area and therefore the regulator portion;
the valve portion includes a stop valve configured to selectively stop gas flow through the valve portion; and
the regulator inlet and the regulator outlet are connected to the valve portion and define a portion of the fluid path.

14. The gas valve and regulator assembly of claim 13, wherein:
the housing includes a release valve having a release valve inlet adjacent the inlet, the release valve allowing pressure in a source of gas connected to the assembly to decrease when the pressure rises above a certain level, the release valve being located in a release valve fluid path through the housing, the release valve fluid path not being fluidly connected to the fluid path.

15. The gas valve and regulator assembly of claim 13, further including:
a backcheck valve for preventing flow of gas into the regulator cavity through the regulator outlet.

16. The gas valve and regulator assembly of claim 15, wherein:
the backcheck valve includes a backcheck spring biasing a backcheck disc into engagement with a backcheck housing, the backcheck disc preventing fluid flow into the regulator cavity through the regulator outlet.

17. The gas valve and regulator assembly of claim 13, wherein:
the valve portion includes a first section and a second section;
the first section has a first section fluid path, a first section inlet to the first section fluid path and a first section outlet allowing gas to leave the first section fluid path; and
the second section has a second section fluid path, a second section inlet to the second section fluid path and a second section outlet allowing gas to leave the second section fluid path; and
further including a backcheck valve for allowing gas to leave the second section of the valve portion and enter the first section of the valve portion, the backcheck valve allowing gas to flow to the first section when the stop valve is open, the regulator portion is closed and pressure between the regulator portion and the valve portion is above a certain level.

18. The gas valve and regulator assembly of claim 17, wherein:
the backcheck valve includes a backcheck spring biasing a backcheck disc into engagement with a backcheck housing, the backcheck disc preventing fluid flow into the regulator cavity through the regulator outlet.

19. The gas valve and regulator assembly of claim 13, wherein:
the stop valve allows for positive shut off of fluid flow through the fluid path.

20. The gas valve and regulator assembly of claim 13, wherein:
the stop valve stops fluid flow through the valve portion.

21. The gas valve and regulator assembly of claim 13, wherein:
the regulator inlet and regulator outlet are substantially parallel.

22. The gas valve and regulator assembly of claim 13, wherein:
the valve portion includes a valve module for preventing fluid flow through the valve portion until a probe is inserted into the assembly through the outlet.

23. The gas valve and regulator assembly of claim 13, further including:
an excess control flow device for preventing excess flow through the fluid path, the excess flow device having a body configured to abut a member when the flow through the fluid path exceeds a certain amount.

24. The gas valve and regulator assembly of claim 23, wherein:
the excess control flow device is located in the valve portion.

25. A gas valve and regulator assembly comprising:
a housing having an inlet, an outlet and a fluid path between the inlet and the outlet, the housing including a regulator cavity having an area separating the regulator cavity into a first zone and a second zone;
a covering member configured to selectively cover the area;
a diaphragm operatively connected to the covering member for selectively moving the covering member to cover the area;
a biasing member biasing the diaphragm to a position such that the covering member covers the area;
wherein the diaphragm is configured to move against the biasing member when pressure in the first area is above a predetermined amount, thereby forcing the covering member to cover the area such that fluid is not able to pass through the area and therefore the housing; and
a valve configured to selectively stop gas flow through the housing and through the regulator cavity;
wherein the valve is not functionally connected to the diaphragm such that movement of the valve will not move the diaphragm; and
wherein the valve is not functionally connected to the covering member such that movement of the valve will not move the covering member.
